(19) United States
(12) Patent Application Publication
(10) Pub. No.: US 2026/0103042 A1
(43) Pub. Date: Apr. 16, 2026

(54) SEAT BELT COOLING SYSTEM

(71) Applicants: Hyundai Motor Company, Seoul (KR); Kia Corporation, Seoul (KR)

(72) Inventors: Baek Hee Lee, Hwaseong (KR); Yo Seob Lee, Hwaseong (KR); Sang Ji Moon, Hwaseong (KR); Won Seok Lee, Hwaseong (KR); Soong Un Choi, Hwaseong (KR); Min Hyuk Kwak, Hwaseong (KR); Kang Yen Lee, Hwaseong (KR)

(21) Appl. No.: 19/083,254

(22) Filed: Mar. 18, 2025

(30) Foreign Application Priority Data
Oct. 16, 2024 (KR) 10-2024-0140792

(51) Int. Cl. B60H 1/00; B60H 1/24; B60R 22/20; B60R 22/24; B60R 22/34

(52) U.S. Cl. CPC B60H 1/00271; B60H 1/243; B60R 22/20; B60R 22/24; B60H 2001/003; B60R 22/34

(57) ABSTRACT

Disclosed is a vehicle seat belt cooling system configured to operate, in response to a remote control signal, a cooler in a duct mounted in a pillar trim before a passenger enters a vehicle in summer, to raise a seat belt, that is, a webbing toward an inlet/outlet of the webbing of the pillar trim, the inlet/outlet communicating with a discharge part of the duct, and to cool the webbing in advance using cold air discharged from the cooler, thereby providing a fresh, cool feeling to the passenger when the passenger enters the vehicle and fastens the seat belt.

### CROSS-REFERENCE TO RELATED APPLICATION

This application claims, under 35 U.S.C. §119(a), the benefit of Korean Patent Application No. 10-2024-0140792, filed on Oct. 16, 2024, the entire contents of which are incorporated herein by reference.

### BACKGROUND

### Technical Field

The present disclosure relates to a seat belt cooling system, and more particularly, to a vehicle seat belt cooling system configured to cool a seat belt before a passenger enters a vehicle, thereby providing a fresh, cool feeling or cooling sensation to the passenger when the passenger fastens the seat belt after entering the vehicle.

### BACKGROUND

When a vehicle is parked outdoors for a long period of time in summer, a seat on which a passenger sits, a seat belt, and the like may be heated due to direct sunlight or the like entering the vehicle interior.

Then, when the passenger sits on the heated seat and fastens the heated seat belt, the passenger may have an unpleasant feeling due to the high temperatures thereof being applied to the body.

Additionally, even if the passenger operates the cooling mode of an air conditioner and also operates a seat ventilation system configured to discharge air from the seat, the passenger continues to be hot for a certain period of time until cold air is discharged from an air vent and the seat.

Furthermore, even if the cooling mode of the air conditioner and the seat ventilation system configured to discharge air from the seat are operated as described above, the unpleasant feeling of the passenger may continue due to the heat that is continuously transferred from the seat belt to particular body parts of the passenger, such as the shoulders, the chest, and the stomach.

### SUMMARY OF THE DISCLOSURE

The present disclosure has been made in an effort to solve the above-described problems associated with the prior art, and it is an object of the present disclosure to provide a vehicle seat belt cooling system configured to operate, in response to a remote control signal, a cooler in a duct mounted in a pillar trim before a passenger enters a vehicle in summer, to raise a seat belt, that is, a webbing toward an inlet/outlet of the webbing of the pillar trim, the inlet/outlet communicating with a discharge part of the duct, and to cool the webbing in advance using cold air discharged from the cooler, thereby providing a fresh, cool feeling to the passenger when the passenger enters the vehicle and fastens the seat belt.

In some embodiments, the present disclosure provides a vehicle seat belt cooling device including a pillar trim having a webbing inlet/outlet formed in an upper portion thereof, the pillar trim having slide holes formed in an upward-and-downward direction toward the webbing inlet/outlet, an anchor coupled to the slide holes of the pillar trim, the anchor being movable upwards and downwards along the slide holes, a webbing having one end connected to the anchor and the other end wound around a retractor 23 mounted in the pillar trim, a duct mounted on an inner surface of the pillar trim, the duct being configured to transfer a cold air current to the webbing inlet/outlet, a cooler mounted on a lower portion of the duct, the cooler being configured to discharge the cold air current to the webbing inlet/outlet along the duct, and a driving device for anchor upward/downward movement mounted between the pillar trim and the duct, the driving device for anchor upward/downward movement being connected to the anchor through the slide holes.

In a preferred embodiment, the pillar trim may have an electromagnet mounted on a lower inner surface thereof, the electromagnet being configured to fix the anchor by magnetic force thereof.

In another preferred embodiment, the vehicle seat belt cooling device may further include a controller configured to perform driving control on the cooler and the driving device for anchor upward/downward movement, the controller being configured to perform a control operation to apply or cut off current to the electromagnet.

In still another preferred embodiment, the controller may be configured to perform, when the anchor is to be moved upwards toward the webbing inlet/outlet, current cut-off control on the electromagnet, and to perform, when the anchor is to be fixed to an original position thereof, current application control on the electromagnet.

In yet another preferred embodiment, the vehicle seat belt cooling device may further include permanent magnets respectively attached to upper and lower portions of the electromagnet, wherein each of the permanent magnets has weaker magnetic force than the magnetic force of the electromagnet such that the anchor is fixed to the original position when current applied to the electromagnet is cut off due to a turned-off vehicle engine.

In still yet another preferred embodiment, the anchor may further have a metal plate attached to an inner side thereof, the metal plate being attachable to the electromagnet and the permanent magnet.

In a further preferred embodiment, the vehicle seat belt cooling device may further include a smart device configured to transmit, to the controller, a remote control signal to drive the cooler for generation of the cold air current and to drive the driving device for anchor upward/downward movement for upward movement of the anchor.

In another further preferred embodiment, the vehicle seat belt cooling device may further include a temperature sensor configured to detect a temperature of the webbing and to transmit a webbing temperature detection signal to the controller.

In still another further preferred embodiment, the controller may be configured, upon receiving the webbing temperature detection signal from the temperature sensor, to determine, when the current temperature of the webbing is equal to or higher than a set temperature, driving of the cooler so as to generate the cold air current and driving of the driving device for anchor upward/downward movement so as to perform upward movement of the anchor.

In yet another further preferred embodiment, the vehicle seat belt cooling device may further include a passenger seating detector configured to detect whether a passenger sits on a seat and to transmit a detection signal to the controller.

In still yet another further preferred embodiment, the controller may be configured to perform, upon receiving the detection signal from the passenger seating detector, a control operation to stop driving of the cooler and a control operation to cause the driving device for anchor upward/downward movement to move the anchor downwards to a position allowing the anchor to be attached to the electromagnet.

In a still further preferred embodiment, the duct may include a main duct mounted on the inner surface of the pillar trim, and a slide duct withdrawably inserted into an upper portion of the main duct, the slide duct having an upper end connected to a height adjuster panel arranged on the inner surface of the pillar trim, the height adjuster panel being configured to adjust a height thereof.

In a yet still further preferred embodiment, the cooler may include an insulation bracket mounted on and fixed to one side of the retractor, a thermoelectric element mounted in a hollow portion formed in the insulation bracket, a cooling plate mounted on one side of the thermoelectric element with the insulation bracket interposed therebetween, a heat dissipation plate mounted on the other side of the thermoelectric element with the insulation bracket interposed therebetween, a cooling fan mounted on an outer surface of the cooling plate, the cooling fan being driven to generate a cold air current using cold air from the cooling plate, and a heat dissipation fan mounted on an outer surface of the heat dissipation plate, the heat dissipation fan being driven to dissipate, to an outside thereof, heat from the heat dissipation plate.

In a yet preferred embodiment, the driving device for anchor upward/downward movement may include a chain coupled to chain sprockets mounted inside the duct, the chain being rotatably movable in the upward-and-downward direction, a guide pin having an outer end connected to an inner side of the anchor, the guide pin having an inner end connected to the chain through the slide hole, and a motor connected to one of the chain sprockets so as to output rotational power thereto.

In some embodiments, a method of cooling a seat belt in a vehicle prior to a passenger entering the vehicle in summer includes: receiving, by a controller, a remote control signal transmitted from a smart device to drive a cooler that generates a cold air current and to drive a driving device for upward movement of an anchor; cutting off current to an electromagnet mounted on an inner surface of a pillar trim, thereby allowing the anchor—connected to one end of a seat belt webbing—to move upwards along slide holes formed in an upward-and-downward direction toward a webbing inlet/outlet; operating the cooler to discharge the cold air current to the webbing inlet/outlet along a duct mounted on an inner surface of the pillar trim; and cooling the webbing in a state in which the anchor is moved upwards by the driving device.

The method may further include detecting, by a temperature sensor, a temperature of the webbing or the vehicle interior, and automatically determining, when the temperature is equal to or higher than a set temperature, to perform reception of the remote control signal and operation of the cooler so as to generate the cold air current.

The method may further include detecting, by a passenger seating detector, that a passenger has sat on a seat; stopping driving of the cooler; and moving the anchor downwards to an original position of the slide holes by applying current to the electromagnet, thereby allowing the passenger to fasten the seat belt.

In some embodiments, a seat belt cooling system for a vehicle includes: a pillar trim having a webbing inlet/outlet formed in an upper portion thereof and slide holes formed in an upward-and-downward direction toward the webbing inlet/outlet; an anchor coupled to the slide holes of the pillar trim and movable upwards and downwards along the slide holes; a webbing having one end connected to the anchor and the other end wound around a retractor mounted in the pillar trim; an electromagnet mounted on a lower inner surface of the pillar trim, configured to fix the anchor by magnetic force; a duct mounted on an inner surface of the pillar trim and configured to transfer a cold air current to the webbing inlet/outlet; a cooler mounted on a lower portion of the duct, configured to discharge the cold air current to the webbing inlet/outlet along the duct; a driving device for anchor upward/downward movement mounted between the pillar trim and the duct and connected to the anchor through the slide holes; a smart device configured to transmit, to a controller, a remote control signal to drive the cooler for generation of the cold air current and to drive the driving device for upward movement of the anchor; and a controller configured to perform driving control on the cooler and the driving device and to perform a control operation to apply or cut off current to the electromagnet, wherein, in response to the remote control signal from the smart device, the controller is configured to cut off current to the electromagnet so that the anchor becomes movable upwards along the slide holes and to operate the cooler to direct the cold air current toward the webbing inlet/outlet, thereby cooling the webbing before a passenger enters the vehicle.

The seat belt cooling system may further include permanent magnets respectively attached to upper and lower portions of the electromagnet, each of the permanent magnets having weaker magnetic force than the magnetic force of the electromagnet, such that the anchor is fixed to an original position thereof when current applied to the electromagnet is cut off due to a turned-off vehicle engine.

The seat belt cooling system may further include a passenger seating detector configured to detect whether a passenger sits on a seat and to transmit a detection signal to the controller, wherein, upon receiving the detection signal, the controller is configured to stop driving of the cooler and to cause the driving device to move the anchor downwards to a position allowing the anchor to be attached to the electromagnet.

As discussed, the method and system suitably include use of a controller or processer.

In another embodiment, vehicles are provided that comprise an apparatus as disclosed herein.

Other embodiments of the disclosure are discussed infra.

It is understood that the terms “vehicle”, “vehicular”, and other similar terms as used herein are inclusive of motor vehicles in general, such as passenger automobiles including sport utility vehicles (SUV), buses, trucks, various commercial vehicles, watercraft including a variety of boats and ships, aircraft, and the like, and include hybrid vehicles, electric vehicles, plug-in hybrid electric vehicles, hydrogen-powered vehicles, and other alternative fuel vehicles (e.g., fuels derived from resources other than petroleum). As referred to herein, a hybrid vehicle is a vehicle that has two or more sources of power, for example, vehicles powered by both gasoline and electricity.

The above and other features of the disclosure are discussed infra.

### BRIEF DESCRIPTION OF THE DRAWINGS

The above and other features of the present disclosure will now be described in detail with reference to certain exemplary embodiments thereof illustrated in the accompanying drawings which are given hereinbelow by way of illustration only, and thus are not limitative of the present disclosure, and wherein:

FIG. 1 is a block diagram showing a configuration of a seat belt cooling system according to the present disclosure;

FIG. 2 is a front view of the seat belt cooling system according to the present disclosure;

FIG. 3 is a rear perspective view of the seat belt cooling system according to the present disclosure;

FIG. 4 is a partially enlarged perspective view of a duct connection structure among the configurations of the seat belt cooling system according to the present disclosure;

FIG. 5 is a front cross-sectional view of the seat belt cooling system according to the present disclosure;

FIG. 6 is a side cross-sectional view of the seat belt cooling system according to the present disclosure;

FIG. 7 is a front view showing a state in which, among the configurations of the seat belt cooling system according to the present disclosure, an anchor is fixed to the original position thereof;

FIG. 8 is a side cross-sectional view showing a state in which, among the configurations of the seat belt cooling system according to the present disclosure, the anchor is fixed to the original position thereof;

FIG. 9 is a front view showing a state in which, among the configurations of the seat belt cooling system according to the present disclosure, the anchor is moved upwards toward an inlet/outlet of a webbing;

FIG. 10 is a side cross-sectional view showing a state in which, among the configurations of the seat belt cooling system according to the present disclosure, the anchor is moved upwards toward the inlet/outlet of the webbing; and

FIG. 11 is a flowchart showing the operation flow of the seat belt cooling system according to the present disclosure.

It should be understood that the appended drawings are not necessarily to scale, presenting a somewhat simplified representation of various preferred features illustrative of the basic principles of the disclosure. The specific design features of the present disclosure as disclosed herein, including, for example, specific dimensions, orientations, locations, and shapes will be determined in part by the particular intended application and use environment.

In the figures, reference numbers refer to the same or equivalent parts of the present disclosure throughout the several figures of the drawing.

### DETAILED DESCRIPTION

Hereinafter, reference will be made in detail to various embodiments of the present disclosure, examples of which are illustrated in the accompanying drawings and described below. Specific structural or functional descriptions given in connection with the embodiments of the present disclosure are merely illustrative for the purpose of describing embodiments according to the concept of the present disclosure, and the embodiments according to the concept of the present disclosure may be implemented in various forms. Further, it will be understood that the present description is not intended to limit the disclosure to the embodiments. On the contrary, the disclosure is intended to cover not only the embodiments, but also various alternatives, modifications, equivalents, and other embodiments, which may be included within the spirit and scope of the disclosure as defined by the appended claims.

Meanwhile, in the present disclosure, terms such as “first” and/or “second” may be used to describe various components, but the components are not limited by the terms. The terms are used only for the purpose of distinguishing one component from other components. For example, a first component may be referred to as a second component, and similarly, a second component may also be referred to as a first component without departing from the scope of rights according to the concept of the present disclosure.

When one component is referred to as being “connected” or “joined” to another component, the one component may be directly connected or joined to the other component, but it should be understood that other components may be present therebetween. On the other hand, when the one component is referred to as being “directly connected to” or “directly in contact with” the other component, it should be understood that other components are not present therebetween. Other expressions for the description of relationships between components, that is, “between” and “directly between” or “adjacent to” and “directly adjacent to”, should be interpreted in the same manner.

The same reference numerals represent the same components throughout the specification. Additionally, the terms in the specification are used merely to describe embodiments and are not intended to limit the present disclosure. In this specification, an expression in a singular form also includes a plural form, unless clearly specified otherwise in context. As used herein, expressions such as “comprise” and/or “comprising” do not exclude the presence or addition of one or more components, steps, operations, and/or elements other than those described.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. These terms are merely intended to distinguish one component from another component, and the terms do not limit the nature, sequence or order of the constituent components. As used herein, the term “and/or” includes any and all combinations of one or more of the associated listed items. In addition, the terms “unit”, “-er”, “-or”, and “module” described in the specification mean units for processing at least one function and operation, and can be implemented by hardware components or software components and combinations thereof.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor and is specifically programmed to execute the processes described herein. The memory is configured to store the modules and the processor is specifically configured to execute said modules to perform one or more processes which are described further below.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”.

Hereinafter, a preferred embodiment of the present disclosure will be described in detail with reference to the accompanying drawings.

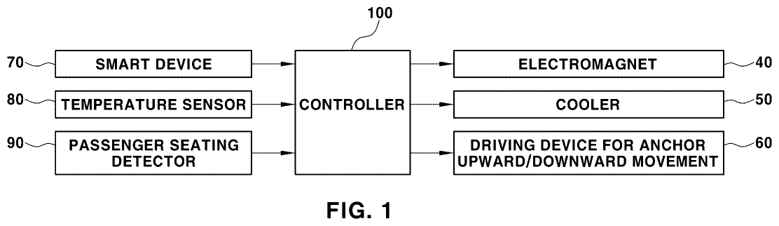

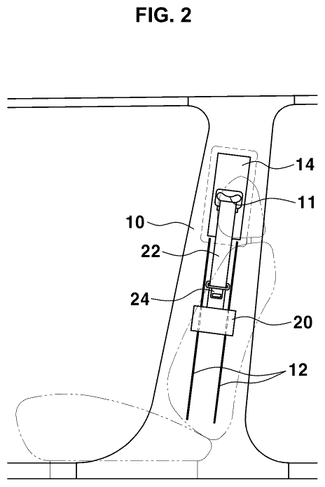

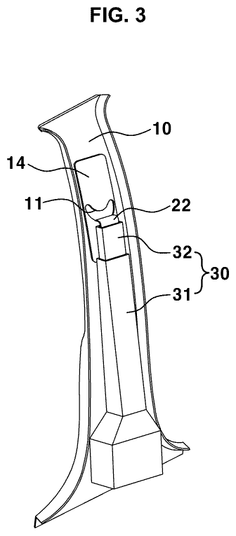

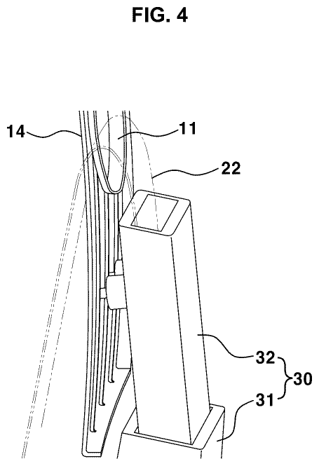

FIG. 1 is a block diagram showing a configuration of a seat belt cooling system according to the present disclosure, FIG. 2 is a front view of the seat belt cooling system according to the present disclosure, FIG. 3 is a rear perspective view of the seat belt cooling system according to the present disclosure, and FIG. 4 is a partially enlarged perspective view of a duct connection structure among the configurations of the seat belt cooling system according to the present disclosure.

A center pillar is installed at a boundary position between a front door and a rear door in the vehicle interior, and the outer surface of the center pillar is formed of a pillar trim which is a type of interior material.

Referring to FIG. 2, a webbing inlet/outlet 11 is formed on an upper portion of a pillar trim 10, and slide holes 12 serving as an upward/downward movement path of an anchor 20 are formed on a lower portion of the webbing inlet/outlet 11.

Preferably, the slide holes 12 are formed in two rows in the upward-and-downward direction from the position of the lower end of the pillar trim 10 where the anchor 20 is fixed to the position directly below the webbing inlet/outlet 11.

Accordingly, in a state in which the anchor 20 is connected to the slide holes 12 of the pillar trim 10 in a vertically movable manner, when the anchor 20 is moved downwards to the lowest position (original position) of the slide hole 12, the anchor may maintain the fixed state thereof at the original position by an electromagnet 40 to be described below, and when the anchor 20 is moved upwards to the highest position of the slide hole 12, the anchor 20 may be positioned outside the webbing inlet/outlet 11.

Referring to FIG. 3, the webbing inlet/outlet 11 is formed in a height adjuster panel 14 configured to adjust the height of the seat belt depending on the body shape of the passenger, and the height adjuster panel 14 is coupled to a height adjuster rail (not shown) mounted on the inner surface of the pillar trim 10 in a vertically movable manner.

Particularly, a duct 30 configured to transfer cold air toward the webbing inlet/outlet 11 is mounted on the inner surface of the pillar trim 10.

As shown in FIG. 3, the duct 30 may be formed of a main duct 31 mounted on the inner surface of the pillar trim 10 so as to be arranged in the upward-and-downward direction, and a slide duct 32 inserted into an upper opening of the main duct 31 so as to be withdrawable from the upper opening.

In this case, the upper portion of the slide duct 32 is connected to the height adjuster panel 14 such that, when the height adjuster panel 14 for adjustment of the height of a seat belt is moved upwards or downwards, a part of the slide duct 32 may be withdrawn from the main duct 31 or may be further inserted into the main duct 31.

In addition, since the upper opening of the slide duct 32 is located directly below the webbing inlet/outlet 11, as described below, the cold air current flowing through the main duct 31 and the slide duct 32 may be discharged toward the webbing inlet/outlet 11.

Meanwhile, one end of the webbing 22, the one end entering or exiting the webbing inlet/outlet 11, is connected to the anchor 20, and the other end of the webbing 22 is wound so as to be able to enter or exit a retractor 23 mounted inside the pillar trim 10.

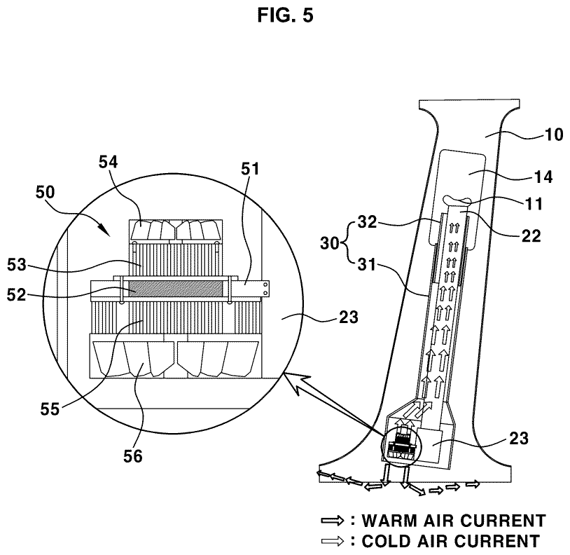

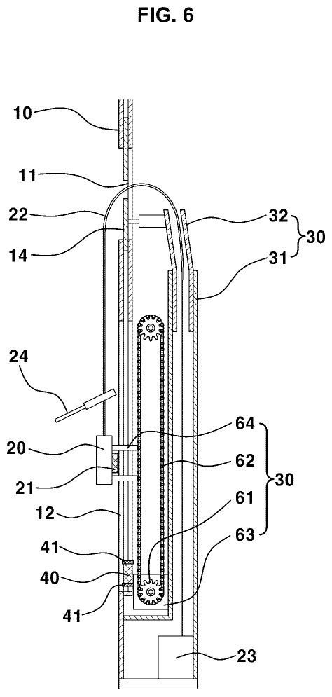

Referring to FIGS. 5 and 6, the retractor 23 may be mounted on the bottom surface of the main duct 31 among the configurations of the duct 30.

Accordingly, a rear end section of a length section of the webbing 22 withdrawn from the retractor 23 may be arranged along the main duct 31 and the slide duct 32, and a front end section thereof may be arranged on the outside of the pillar trim 10 by passing through the webbing inlet/outlet 11.

Here, a tongue 24 to be coupled to a buckle (not shown) is inserted into the webbing 22 arranged on the outside of the pillar trim 10, and the anchor 20 is connected to one end of the webbing 22, that is, the end of the webbing 22 arranged on the outside of the pillar trim 10.

Referring to FIG. 6, the electromagnet 40 configured to fix the anchor 20 by magnetic force thereof is mounted on the inner surface of the lower side of the pillar trim 10.

Accordingly, when the electromagnet 40 becomes magnetic by current application control of a controller 100, the anchor 20 may be strongly attached to the electromagnet 40 with the pillar trim 10 interposed therebetween. On the other hand, when the electromagnet 40 loses magnetic force by current cut-off control of the controller 100, the anchor 20 becomes movable upwards and downwards along the slide hole 12 of the pillar trim 10.

Additionally, when current application to the electromagnet 40 is cut off due to a turned-off vehicle engine, in order to fix the anchor 20 to the original position thereof (for example, the lowest position of the slide hole 12 on the outer surface of the pillar trim 10), permanent magnets 41 each having weaker magnetic force than magnetic force of the electromagnet 40 may be respectively attached to the upper portion of the electromagnet 40 and the lower portion thereof.

Preferably, a metal plate 21 capable of being attached to the electromagnet 40 and the permanent magnets 41 may be further attached to the inner side of the anchor 20.

As shown in FIG. 5, a cooler 50 configured to discharge a cold air current through the main duct 31 and the slide duct 32 to the webbing inlet/outlet 11 is mounted in the lower space of the duct 30, that is, the bottom surface of the main duct 31 among the configurations of the duct 30.

As shown in the enlarged view of FIG. 5, the cooler 50 may include an insulation bracket 51 mounted on and fixed to one side of the retractor 23, a thermoelectric element 52 mounted in a hollow portion formed in a central portion of the insulation bracket 51, a cooling plate 53 mounted on one side of the thermoelectric element 52 with the insulation bracket 51 interposed therebetween, and a heat dissipation plate 55 mounted on the other side of the thermoelectric element 52 with the insulation bracket 51 interposed therebetween.

In addition, a cooling fan 54 driven to generate a cold air current using cold air from the cooling plate 53 is mounted on the outer surface of the cooling plate 53, and a heat dissipation fan 56 driven to dissipate heat from the heat dissipation plate 55 to the outside is mounted on the outer surface of the heat dissipation plate 55.

For reference, the thermoelectric element 52 is also known as a Peltier element. When current is applied to the thermoelectric element 52, one side of the thermoelectric element 52 becomes cold and the other side thereof becomes warm.

At this time, the insulation bracket 51 has a plate shape made of an insulating material and serves to block heat exchange between cold air and hot air generated from the thermoelectric element 52.

Therefore, when current is applied to the thermoelectric element 52, the cooling fan 54, and the heat dissipation fan 56, a plurality of processes including a process of transferring cold air to the cooling plate 53 in a state in which one side of the thermoelectric element 52 becomes cold, a process of generating a cold air current from the cold air of the cooling plate 53 by driving of the cooling fan 54, and a process of discharging the generated cold air current to the webbing inlet/outlet 11 through the main duct 31 and the slide duct 32 may be performed.

In addition, a plurality of processes including a process of transferring warm air to the heat dissipation plate 55 in a state in which the other side of the thermoelectric element 52 becomes warm, a process of generating a warm air current from the warm air of the heat dissipation plate 55 by driving of the heat dissipation fan 56, and a process of discharging the generated warm air current to the outside through a discharge hole formed in the lower end of the main duct 31 may be performed.

Meanwhile, in order to move the anchor 20 upwards along the slide hole 12 of the pillar trim 10, a driving device for anchor upward/downward movement 60 connected to the anchor 20 through the slide hole 12 is installed between the pillar trim 10 and the duct 30.

As shown in FIG. 6, the driving device for anchor upward/downward movement 60 may be configured to include a chain 62 rotatably connected to chain sprockets 61 mounted inside the duct 30 in the upward-and-downward direction, a guide pin 64 connecting the anchor 20 to the chain 62, and a motor 63 connected to one of the chain sprockets 61 so as to output rotational power thereto.

In this case, the outer end of the guide pin 64 is connected to an inner portion of the anchor 20, and the inner end thereof passes through the slide hole 12 of the pillar trim 10 so as to be connected to a predetermined position of the chain 62.

Therefore, when current is applied to the motor 63 such that the motor is rotatably driven in one direction, the chain 62 is moved upwards in a rotatable manner, and simultaneously, the guide pin 64 is moved upwards along the slide hole 12. Further, the anchor 20 connected to the guide pin 64 is also moved upwards and is located directly below the webbing inlet/outlet 11.

On the other hand, when current is applied to the motor 63 and the motor is rotatably driven in the other direction, the chain 62 is moved downwards in a rotatable manner, and simultaneously, the guide pin 64 is moved downwards along the slide hole 12. Further, the anchor 20 connected to the guide pin 64 is also moved downwards to the lowest position of the slide hole 12 of the pillar trim 10 (original position) and may maintain the fixed state thereof at the original position. Furthermore, since the anchor 20 is attached to the electromagnet 40 by magnetic force, the anchor may more reliably maintain the fixed state thereof at the original position.

The seat belt cooling system according to the present disclosure further includes a smart device 70 configured to transmit, to the controller 100, a remote control signal to drive the cooler 50 for generation of a cold air current and to drive the driving device for anchor upward/downward movement 60 for upward movement of the anchor, and the smart device 70 may be a smartphone to which a dedicated application is downloaded.

Therefore, the controller 100 is configured to perform driving control for the cooler 50 and the driving device for anchor upward/downward movement 60 in response to the remote control signal of the smart device 70, and to perform current cut-off control or current application control on the electromagnet 40.

Specifically, the controller 100 may be configured to perform the current cut-off control on the electromagnet 40 when the anchor 20 is to be moved upwards toward the webbing inlet/outlet 12 of the pillar trim 10. On the other hand, the controller 100 may be configured to perform the current application control on the electromagnet 40 when the anchor 20 is to be fixed to the original position thereof.

In addition, the seat belt cooling system according to the present disclosure further includes a temperature sensor 80 configured to detect the temperature of the webbing and transmit a detected signal to the controller 100. The temperature sensor 80 may be a sensor configured not to directly detect the temperature of the webbing, but to detect the temperature of a steering wheel heated by direct sunlight or the temperature of the vehicle interior in summer.

Accordingly, the controller 100 may be configured to receive a webbing temperature detection signal from the temperature sensor 80, and to determine, when the current temperature of the webbing is higher than a set temperature, driving of the cooler 50 so as to generate a cold air current and driving of the driving device for anchor upward/downward movement 60 so as to move the anchor upwards.

In addition, the seat belt cooling system according to the present disclosure further includes a passenger seating detector 90 configured to detect whether a passenger sits on the seat and to transmit a detection signal to the controller 100, and the passenger seating detector 90 may be a pressure sensor mounted on the seat and configured to detect the seating pressure of the passenger.

Accordingly, upon receiving the detection signal from the passenger seating detector 90, the controller 100 is configured to perform a control operation to stop driving of the cooler 50 and to perform a control operation to cause the driving device for anchor upward/downward movement 60 to move the anchor downwards, thereby allowing the passenger to fasten the seat belt.

In detail, when the controller 100 receives the detection signal from the passenger seating detector 90 and performs the control operation to cause the driving device for anchor upward/downward movement 60 to move the anchor downwards, the anchor 20 connected to the guide pin 64 may be moved downwards to the lowest position (original position) of the slide hole 12 of the pillar trim 10 and may maintain the fixed state thereof, thereby allowing the passenger to fasten the seat belt. Furthermore, since the anchor 20 is magnetically attached to the electromagnet 40, the anchor may more reliably maintain the fixed state thereof at the original position.

Here, the operation flow of the seat belt cooling system having the above-described configuration will be described below.

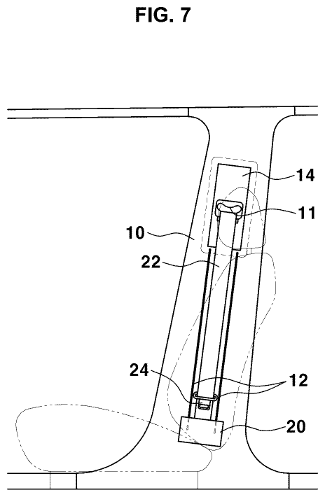

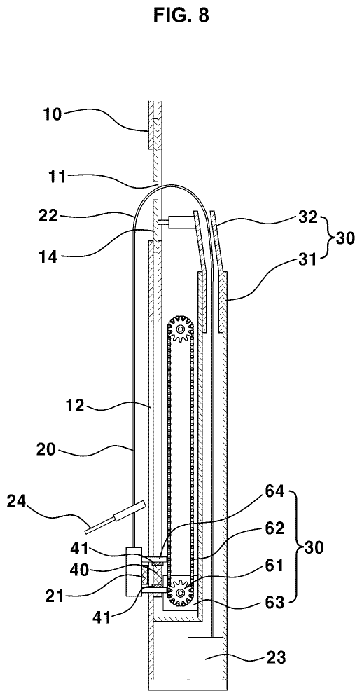

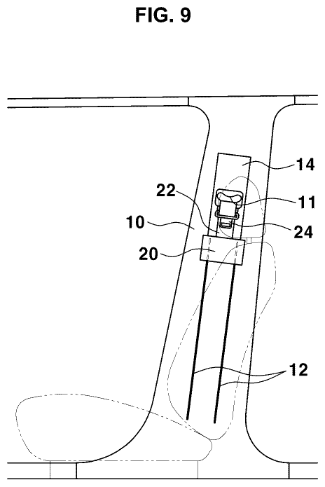

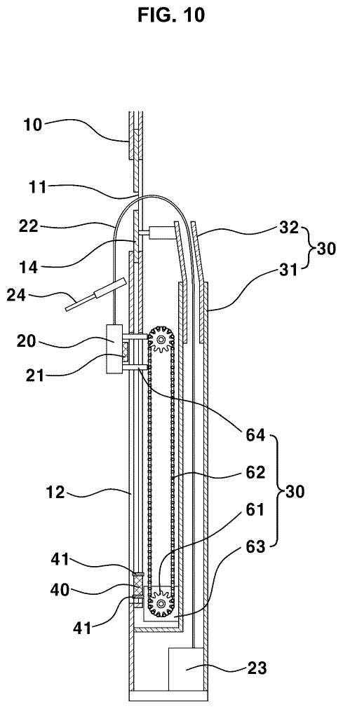

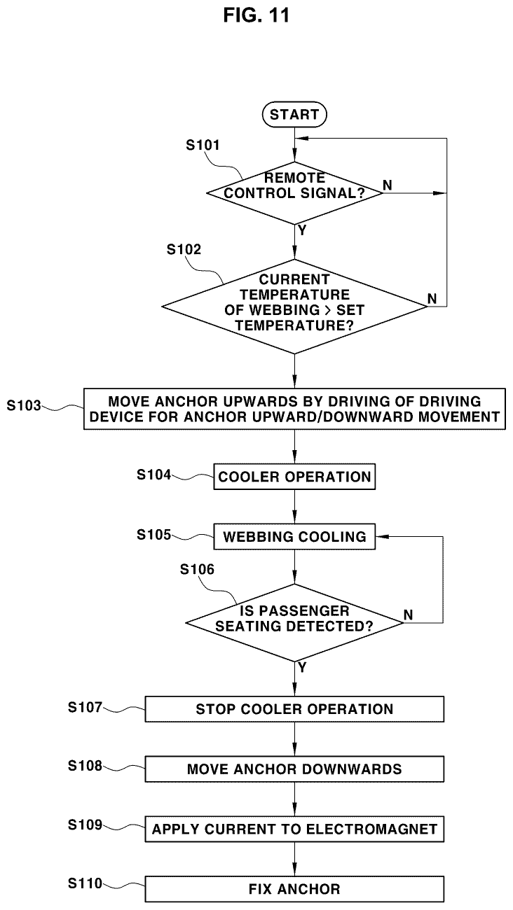

FIGS. 7 and 8 are diagrams each showing a state in which, among the configurations of the seat belt cooling system according to the present disclosure, the anchor is fixed to the original position thereof, FIGS. 9 and 10 are diagrams each showing a state in which, among the configurations of the seat belt cooling system according to the present disclosure, the anchor is moved upwards toward the webbing inlet/outlet, and FIG. 11 is a flowchart showing the operation flow of the seat belt cooling system according to the present disclosure.

As shown in FIGS. 7 and 8, in a state in which the current applied to the electromagnet 40 is cut off due to a turned-off vehicle engine, the anchor 20 may maintain the position thereof in a state of being fixed to the original position (for example, the lowest position of the slide hole 12 on the outer surface of the pillar trim 10) by magnetic force of the permanent magnets 41 respectively located at the upper and lower portions of the electromagnet 40.

Therefore, when the vehicle is parked outside for a long period of time in summer, the seat belt, that is, the webbing 22 having the anchor 20 fixed to one end thereof, may be heated by direct sunlight or the like.

The present disclosure focuses on cooling a seat belt heated by direct sunlight or the like in advance before a passenger enters a vehicle in summer.

To this end, first, the controller 100 checks whether a remote control signal for seat belt cooling is received by the operation of the smart device 70 (S101).

In detail, when a driver operates the smart device 70 in a state in which a vehicle engine is turned off and transmits the remote control signal for seat belt cooling to the controller 100, the controller 100 may confirm that the remote control signal for seat belt cooling has been received.

Then, the controller 100 may receive a webbing temperature detection signal from the temperature sensor 80. Here, when the current temperature of the webbing is higher than a set temperature, the controller may determine driving of the cooler 50 so as to generate a cold air current and driving of the driving device for anchor upward/downward movement 60 so as to move the anchor upwards (S102).

In this case, upon receiving the remote control signal and confirming that the current temperature of the webbing is equal to or higher than the set temperature, the controller 100 performs a control operation to drive the driving device for anchor upward/downward movement 60 so as to move the anchor upwards and a control operation to drive the cooler 50 so as to generate a cold air current.

Accordingly, in response to a control signal from the controller 100, the driving device for anchor upward/downward movement 60 is driven to move the anchor upwards (S103), and the cooler 50 is operated (S104).

In order to move the anchor upwards, driving of the driving device for anchor upward/downward movement 60 may be performed by a plurality of processes including a process of rotating the motor 63 in one direction by applying current to the motor 63 in response to a control signal from the controller 100, a process of rotatably moving the chain 62 upwards and moving the guide pin 64 upwards along the slide hole 12, and a process of moving the anchor 20 connected to the guide pin 64 upwards and positioning the anchor directly below the webbing inlet/outlet 11.

In this manner, the webbing 22 enters the interior of the duct 30 through the webbing inlet/outlet 11 by the upward movement of the anchor 20.

The operation of the cooler 50 may be performed by a plurality of processes including a process of applying current to the thermoelectric element 52, the cooling fan 54, and the heat dissipation fan 56 in response to a control signal from the controller 100, a process of cooling one side of the thermoelectric element 52 and transferring cold air to the cooling plate 53, a process of generating a cold air current from the cold air of the cooling plate 53 by driving of the cooling fan 54, and a process of discharging the generated cold air current to the webbing inlet/outlet 11 through the main duct 31 and the slide duct 32.

Therefore, as shown in FIGS. 9 and 10, in a state in which the webbing 22 enters the inside of the duct 30 in conjunction with upward movement of the anchor 20 by driving of the driving device for anchor upward/downward movement 60 for upward movement of the anchor, when a cold air current generated by the operation of the cooler 50 is discharged through the webbing inlet/outlet 11 along the duct 32, the webbing 22 may be cooled by the cold air current (S106).

Next, a step of detecting whether a passenger enters the vehicle may be performed (S106).

That is, when the passenger sits on a seat, a passenger seating signal detected by the passenger seating detector 90 mounted on the seat may be transmitted to the controller 100.

Subsequently, when the controller 100 receives the detection signal from the passenger seating detector 90, the operation of the cooler 50 is stopped by performing a control operation to stop driving of the cooler 50 (S107), and the anchor 108 is moved downwards to the original position thereof by performing a control operation to move the anchor downwards on the driving device for anchor upward/downward movement 60 (S108).

Accordingly, anchor downward movement driving of the driving device for anchor upward/downward movement 60 may be performed by a plurality of processes including a process of applying current to the motor 63 so as to rotate the motor in the other direction, a process of rotatably moving the chain 62 downwards and simultaneously moving the guide pin 64 downwards along the slide hole 12, and a process of moving the anchor 20 connected to the guide pin 64 downwards to the lowest position (original position) of the slide hole 12 of the pillar trim 10.

Here, a control step of applying, by the controller 100, current to the electromagnet 40 is performed (S109).

Therefore, the anchor 20 connected to the guide pin 64 may be moved downwards to the lowest position (original position) of the slide hole 12 of the pillar trim 10 and may maintain the fixed state thereof at the original position, thereby allowing the passenger to fasten the seat belt. Furthermore, since the anchor 20 is magnetically attached to the electromagnet 40, the anchor may more reliably maintain the fixed state thereof at the original position (S110).

Next, when the passenger fastens the seat belt, that is, the webbing 22, the webbing 22 cooled in advance may provide a fresh, cool feeling to the shoulders, the chest, and the stomach of the passenger, thereby improving ride comfort in summer.

As is apparent from the above description, the present disclosure provides a seat belt cooling system configured to pre-cool a seat belt heated by direct sunlight before a passenger enters a vehicle in summer, and to provide, when the passenger fastens the seat belt, a fresh, cool feeling to the shoulders, the chest, and the stomach of the passenger, thereby improving ride comfort in summer.

Although the present disclosure has been described in detail with reference to one embodiment thereof, the scope of the present disclosure is not limited to the above-described embodiment. However, it will be appreciated by those skilled in the art that various modifications and improvements may be made in the embodiment without departing from the principles and spirit of the disclosure, the scope of which is defined in the appended claims and equivalents thereto.

What is claimed is:

1. A vehicle seat belt cooling device comprising:
a pillar trim having a webbing inlet/outlet formed in an upper portion thereof, the pillar trim comprising slide holes formed in an upward-and-downward direction toward the webbing inlet/outlet;
an anchor coupled to the slide holes of the pillar trim, the anchor being movable upwards and downwards along the slide holes;
a webbing having one end connected to the anchor and the other end wound around a retractor mounted in the pillar trim;
a duct mounted on an inner surface of the pillar trim, the duct being configured to transfer a cold air current to the webbing inlet/outlet;
a cooler mounted on a lower portion of the duct, the cooler being configured to discharge the cold air current to the webbing inlet/outlet along the duct; and
a driving device for anchor upward/downward movement mounted between the pillar trim and the duct, the driving device being connected to the anchor through the slide holes.

2. The vehicle seat belt cooling device of claim 1, wherein the pillar trim comprises an electromagnet mounted on a lower inner surface thereof, the electromagnet being configured to fix the anchor by magnetic force thereof.

3. The vehicle seat belt cooling device of claim 2, further comprising a controller configured to perform driving control on the cooler and the driving device, the controller being configured to perform a control operation to apply or cut off current to the electromagnet.

4. The vehicle seat belt cooling device of claim 3, wherein the controller is configured to perform, when the anchor is to be moved upwards toward the webbing inlet/outlet, current cut-off control on the electromagnet, and to perform, when the anchor is to be fixed to an original position thereof, current application control on the electromagnet.

5. The vehicle seat belt cooling device of claim 2, further comprising permanent magnets respectively attached to upper and lower portions of the electromagnet, configured to retain the anchor in its original position upon de-energization of the electromagnet.

6. The vehicle seat belt cooling device of claim 5, wherein the anchor further comprises a metal plate attachable to the electromagnet and the permanent magnets.

7. The vehicle seat belt cooling device of claim 3, further comprising a smart device configured to transmit, to the controller, a remote control signal to drive the cooler for generation of the cold air current and to drive the driving device for upward movement of the anchor.

8. The vehicle seat belt cooling device of claim 3, further comprising a temperature sensor configured to detect a temperature of the webbing and to transmit a webbing temperature detection signal to the controller.

9. The vehicle seat belt cooling device of claim 8, wherein the controller is configured, upon receiving the webbing temperature detection signal from the temperature sensor, to determine, when the current temperature of the webbing is equal to or higher than a set temperature, driving of the cooler so as to generate the cold air current and driving of the driving device so as to perform upward movement of the anchor.

10. The vehicle seat belt cooling device of claim 3, further comprising a passenger seating detector configured to detect whether a passenger sits on a seat and to transmit a detection signal to the controller.

11. The vehicle seat belt cooling device of claim 10, wherein the controller is configured to perform, upon receiving the detection signal from the passenger seating detector, a control operation to stop driving of the cooler and a control operation to cause the driving device to move the anchor downwards to a position allowing the anchor to be attached to the electromagnet.

12. The vehicle seat belt cooling device of claim 1, wherein the duct comprises:
a main duct mounted on the inner surface of the pillar trim; and
a slide duct withdrawably inserted into an upper portion of the main duct, the slide duct having an upper end connected to a height adjuster panel arranged on the inner surface of the pillar trim, the height adjuster panel being configured to adjust a height thereof.

13. The vehicle seat belt cooling device of claim 1, wherein the cooler comprises:
an insulation bracket mounted on and fixed to one side of the retractor;
a thermoelectric element mounted in a hollow portion formed in the insulation bracket;
a cooling plate mounted on one side of the thermoelectric element with the insulation bracket interposed therebetween;
a heat dissipation plate mounted on the other side of the thermoelectric element with the insulation bracket interposed therebetween;
a cooling fan mounted on an outer surface of the cooling plate, the cooling fan being driven to generate a cold air current using cold air from the cooling plate; and
a heat dissipation fan mounted on an outer surface of the heat dissipation plate, the heat dissipation fan being driven to dissipate, to an outside thereof, heat from the heat dissipation plate.

14. The vehicle seat belt cooling device of claim 1, wherein the driving device comprises:
a chain coupled to chain sprockets mounted inside the duct, the chain being rotatably movable in the upward-and-downward direction;
a guide pin having an outer end connected to an inner side of the anchor, the guide pin having an inner end connected to the chain through the slide hole; and
a motor connected to one of the chain sprockets so as to output rotational power thereto.

15. A method of cooling a seat belt in a vehicle prior to a passenger entering the vehicle in summer, the method comprising:
receiving, by a controller, a remote control signal transmitted from a smart device to drive a cooler for generation of a cold air current and to drive a driving device for upward movement of an anchor;
cutting off current to an electromagnet mounted on an inner surface of a pillar trim, thereby allowing the anchor, which is connected to one end of a webbing of the seat belt, to move upwards along slide holes formed in an upward-and-downward direction toward a webbing inlet/outlet;
operating the cooler to discharge the cold air current to the webbing inlet/outlet along a duct mounted on the inner surface of the pillar trim; and
cooling the webbing in a state in which the anchor is moved upwards toward the webbing inlet/outlet by the driving device.

16. The method of claim 15, further comprising:
detecting, by a temperature sensor, a temperature of the webbing or the vehicle interior; and
automatically determining, when the temperature is equal to or higher than a set temperature, to perform the receiving of the remote control signal and the operating of the cooler so as to generate the cold air current.

17. The method of claim 15, further comprising:
detecting, by a passenger seating detector, that a passenger has sat on a seat;
stopping driving of the cooler; and
moving the anchor downwards to an original position of the slide holes by applying current to the electromagnet, thereby allowing the passenger to fasten the seat belt.

18. A seat belt cooling system for a vehicle, the system comprising:
a pillar trim having a webbing inlet/outlet formed in an upper portion thereof and slide holes formed in an upward-and-downward direction toward the webbing inlet/outlet;
an anchor coupled to the slide holes of the pillar trim and movable upwards and downwards along the slide holes;
a webbing having one end connected to the anchor and the other end wound around a retractor mounted in the pillar trim;
an electromagnet mounted on a lower inner surface of the pillar trim, the electromagnet being configured to fix the anchor by magnetic force;
a duct mounted on an inner surface of the pillar trim and configured to transfer a cold air current to the webbing inlet/outlet;
a cooler mounted on a lower portion of the duct, the cooler being configured to discharge the cold air current to the webbing inlet/outlet along the duct;
a driving device for anchor upward/downward movement mounted between the pillar trim and the duct and connected to the anchor through the slide holes;
a smart device configured to transmit, to a controller, a remote control signal to drive the cooler for generation of the cold air current and to drive the driving device for upward movement of the anchor; and
the controller configured to perform driving control on the cooler and the driving device and to perform a control operation to apply or cut off current to the electromagnet,
wherein, in response to the remote control signal from the smart device, the controller is configured to cut off current to the electromagnet so that the anchor becomes movable upwards along the slide holes and to operate the cooler to direct the cold air current toward the webbing inlet/outlet, thereby cooling the webbing before a passenger enters the vehicle.

19. The seat belt cooling system of claim 18, further comprising:
permanent magnets respectively attached to upper and lower portions of the electromagnet, each of the permanent magnets having weaker magnetic force than the magnetic force of the electromagnet, such that the anchor is fixed to an original position thereof when current applied to the electromagnet is cut off due to a turned-off vehicle engine.

20. The seat belt cooling system of claim 18, further comprising:
a passenger seating detector configured to detect whether a passenger sits on a seat and to transmit a detection signal to the controller,
wherein, upon receiving the detection signal, the controller is configured to stop driving of the cooler and to cause the driving device to move the anchor downwards to a position allowing the anchor to be attached to the electromagnet.
